(19) United States
(12) Patent Application Publication
(10) Pub. No.: US 2018/0363198 A1
(43) Pub. Date: Dec. 20, 2018

(54) WALL MOUNTED WASHING MACHINE AND DOOR THEREOF

(71) Applicant: DONGBU DAEWOO ELECTRONICS CORPORATION, Seoul (KR)

(72) Inventor: Jeong Hyeon GIM, Incheon (KR)

(21) Appl. No.: 15/934,727

(22) Filed: Mar. 23, 2018

(30) Foreign Application Priority Data
Jun. 14, 2017 (KR) 10-2017-0074640

(51) Int. Cl. D06F 37/26; D06F 37/20; D06F 39/00; D06F 39/08; D06F 39/14; D06F 37/10

(52) U.S. Cl. CPC D06F 37/263; D06F 37/206; D06F 39/005; D06F 39/083; F16B 43/001; D06F 37/10; D06F 39/088; D06F 37/262; D06F 39/14

(57) ABSTRACT

A wall mounted washing machine and a door thereof are disclosed, which are capable of fluid or moisture discharge. The wall mounted washing machine includes a cabinet having a front surface and a rear surface to be opened to form an appearance; a tub disposed in the cabinet to store wash water, a front panel installed in the tub; a drum rotatably installed in the tub; a cover installed in the front panel and having a door hinge; and a door rotatably coupled to the door hinge and having a door glass supported by a door inner frame and a door outer frame which are coupled to each other. The door includes a trap portion disposed around the door glass for guiding a fluid flow which flows through a gap between the door glass and the door inner frame.

### CROSS REFERENCE TO RELATED PATENT APPLICATION

The present disclosure claims benefit to Korean Patent Application No. 10-2017-0074640, filed on, Jun. 14, 2017, by inventor Gim Jeong Hyeon, which application is hereby incorporated by reference for all purposes.

### TECHNICAL FIELD

The disclosure relates to relates to a wall mounted washing machine and a door thereof.

### BACKGROUND

A washing machine is a device for separating contaminants from washed fabric (laundry) using wash water and detergent, wherein the contaminants may be separated from the washed fabric by the chemical action of the detergent dissolved in the wash water and the mechanical action of the wash water and an inner basket. Such washing machines may be categorized into a top loading type washing machine, a front loading type washing machine, and a combined type washing machine combined with the top loading type and the front loading type, depending on the method of loading the laundry.

In recent years, wall mounted washing machines have been introduced, which may be installed in narrow spaces such as bathrooms and toilets. In general, the wall mounted washing machines employ the front loading type for better miniaturization.

For example, the wall mounted washing machine may include a cabinet that forms an exterior, a tub provided in the cabinet filled with wash water, a drum rotatably installed in the tub and accommodating the laundry, a drive unit providing power to the drum, a water supply unit for supplying the wash water to the tub, and a drain unit for discharging the wash water from the tub to the outside of the cabinet

A conventional wall mounted washing machine may suffer from moisture generated on a door due to the difference between the water temperature in an internal space of the washing machine drum and the outside atmospheric temperature or the pressure difference associated with the regions inside/outside of the door.

In addition, in the conventional wall mounted washing machine, during a performance test cycle in which water is forcibly sprayed into the washing machine as the water injection test, or during a cleaning cycle of the washing machine, water may flow along the surface of a door glass when the door is opened and then flow into the door through a gap located between the door and the door glass. In this case, because problems may occur with respect to electric or electronic equipment installed in the door, and such problems may include malfunction, failure, and short-circuit, it is very important to prevent excessive water or moisture build-up on the door.

### SUMMARY

In view of the foregoing, embodiments of the disclosure provide a wall mounted washing machine and a door thereof which includes a door opening and closing device having an electronic opening and closing mechanism to safely discharge moisture which may be generated in the door.

Embodiments of the present invention are drawn to a wall mounted washing machine comprising: a cabinet having front and rear surfaces; a tub disposed in the cabinet to store wash water; a front panel disposed in the tub; a drum rotatably installed in the tub; a cover installed in the front panel and comprising a door hinge; and a door rotatably coupled to the door hinge and comprising a door glass supported by a door inner frame and a door outer frame coupled to each other, wherein the door comprises a trap portion disposed around the door glass and for guiding a fluid which is operable to flow through a gap between the door glass and the door inner frame. Embodiments include the above and wherein the door further comprises a disk-like structure and wherein the disk-like structure comprises a display circuit disposed in a lower position of the door glass. Embodiments include the above and wherein the door is a protruding structure having a thin outer thickness which gradually increases toward a center thereof.

Embodiments of the present invention are further drawn to a wall mounted washing machine comprising: a cabinet forming an exterior shape; a tub disposed in the cabinet to store wash water; a drum rotatably installed in the tub; a cover coupled to the cabinet; and a door comprising an inner frame and an outer frame, combined with each other, and operable to shield the cover and to mount a door glass, wherein the door further comprises a trap portion formed on the inner frame and the outer frame and disposed with respect to a lower side of the door glass. Embodiments include the above and wherein the trap portion defines a fluid flow path from a gap between the door glass and the inner frame to a fluid outlet of the inner frame.

Embodiments include the above and wherein the door glass comprises: a glass body having a bulged and substantially cap shape and extending toward the drum; a glass inclined portion in which an outer diameter gradually increases with respect to a direction from the glass body toward the inner frame; a glass extension portion extending in a direction from an end of the glass inclined portion toward the inner frame; and a glass edge portion bent in shape from an end of the glass extension portion in an outward direction perpendicular to the glass extension portion. Embodiments include the above and wherein the door glass further comprises a plurality of positioning protrusions disposed spaced apart from both sides of an upper portion of the glass edge portion. Embodiments include the above and wherein the door glass further comprises a flat portion disposed on a lower side of the glass edge portion.

Embodiments of the present invention are also drawn to a door for a washing machine, the washing machine comprising a cabinet forming an exterior shape; a tub disposed in the cabinet to store wash water; a drum rotatably installed in the tub; and a cover coupled to the cabinet, the door comprising: an inner frame; an outer frame; a display circuit; a door glass; and a trap portion formed on the inner frame and the outer frame and disposed with respect to a position between the door glass and the display circuit. Embodiments include the above and wherein the inner frame comprises: an inner frame hole portion open in a thickness direction from a center of the inner frame and operable to mount the door glass; a plurality of support ribs protruding from an inner side of the inner frame hole portion and spaced apart in a circumferential direction of the inner frame hole portion and operable to support an edge portion of the door glass in a radial direction; and a wall body extending along a circumferential direction of the inner frame from an inner side of the inner frame hole and operable to connect the plurality of supporting ribs together. Embodiments include the above and wherein the wall body of the inner frame is more protruded from the inner side of the inner frame hole portion than a protrusion height of a support rib of the plurality of support ribs. Embodiments include the above and wherein the wall body comprises a closed loop-type wall structure which is formed and combined to correspond with a shape of the edge portion of the door glass.

Embodiments include the above and wherein the wall body comprises: a plurality of positioning groove portions disposed to be spaced apart from each other from an upper portion of the wall body to correspond with positioning protrusions of the edge portion of the door glass; and a first guide wall integrally disposed on a lower side of the wall body to not be in contacted with a corresponding flat portion of the edge portion of the door glass, and wherein further the first guide wall is spaced apart below a gap between the door glass and the inner frame. Embodiments include the above and wherein the gap comprises an opening formed between an outer side of the edge portion of the door glass and an inner side of the inner frame hole portion of the inner frame. Embodiments include the above and wherein the outer frame comprises: an outer frame hole portion open in a thickness direction from a center of the outer frame and operable to mount the door glass and to support an inner side of the edge portion of the door glass in a thickness direction of the door; an outer frame hole reinforcing part spaced apart from an outside of the inner frame hole portion; and a plurality of connecting ribs connecting the inner frame hole portion and the inner frame hole reinforcing portion together. Embodiments include the above and wherein the inner frame hole reinforcing portion of the outer frame comprises a second guide wall integrally disposed on a lower side of the inner frame hole reinforcing portion to be spaced apart from and parallel to the first guide wall from a position above the first guide wall of the inner frame.

Embodiments include the above and wherein the outer frame further comprises a circuit receiving portion spaced apart from a lower side of the inner frame hole reinforcing portion and integrally formed on an inner side of the outer frame and operable for receiving the display circuit. Embodiments include the above and wherein the first guide wall of the wall body of the inner frame is disposed within a space between an upper end of the circuit receiving portion of the outer frame and the second guide wall of the inner frame hole reinforcing portion to form the trap portion. Embodiments include the above and wherein the trap portion comprises: a first flow path spatially coupled to the gap and extending into a space between an upper surface of the first guide wall and a lower surface of the second guide wall; a return flow path spatially coupled to the first flow path and switching a fluid flow direction of the first flow path in an opposite direction; a second flow path spatially coupled to the return flow path and extending into a space between an upper surface of the upper end of the circuit receiving portion and a lower surface of the first guide wall; and a down flow path formed from an outlet of the second flow path to a fluid outlet of a lower portion of the inner frame and along an inner side of the inner frame. Embodiments include the above and wherein the fluid outlet comprises a plurality of holes penetrating the lower portion of the inner frame with respect to a direction toward the cover and operable to function as a drain hole.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view showing the appearance of a wall mounted washing machine according to an embodiment of the present disclosure;

FIG. 2 is a view showing a state in which the door of FIG. 1 is opened.

FIG. 3 is a rear perspective view of the washing machine of FIG. 1;

FIG. 4 is an exploded perspective view of the washing machine of FIG. 1;

FIG. 5 is an exploded perspective view of the door shown in FIG. 4;

FIG. 6 is a perspective view showing the inner side of the door outer frame shown in FIG. 5;

FIG. 7 is a rear view showing the outer side of the door inner frame shown in FIG. 5;

FIG. 8 is a front view of an assembly of a door except for the protective glass in FIG. 5;

FIG. 9 is a cross-sectional view taken along the line A-A in FIG. 8;

FIG. 10 is an enlarged view of a circle B in FIG. 9; and

FIG. 11 is an enlarged view of a circle C in FIG. 9.

### DETAILED DESCRIPTION

Hereinafter, specific embodiments of the present disclosure will be described in detail with reference to the drawings.

In addition, in the description of the present disclosure, the detailed description of known functions and configurations incorporated herein will be omitted if they would unnecessarily obscure the features of the subject matter of the present disclosure.

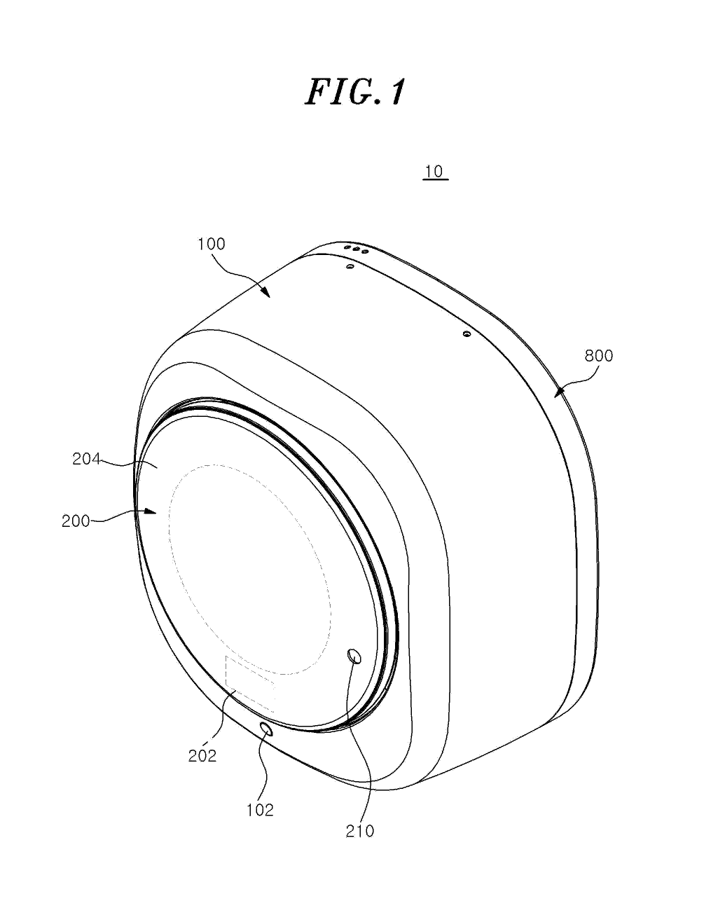

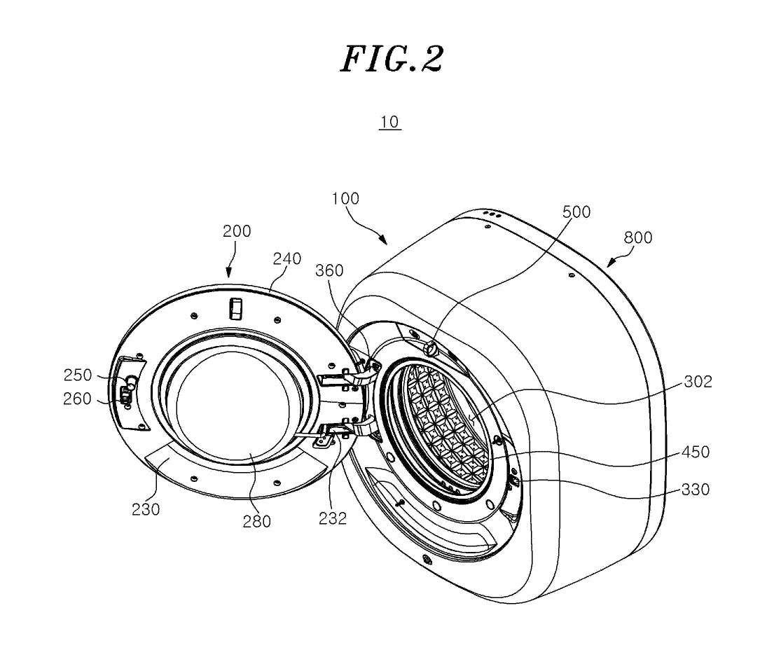

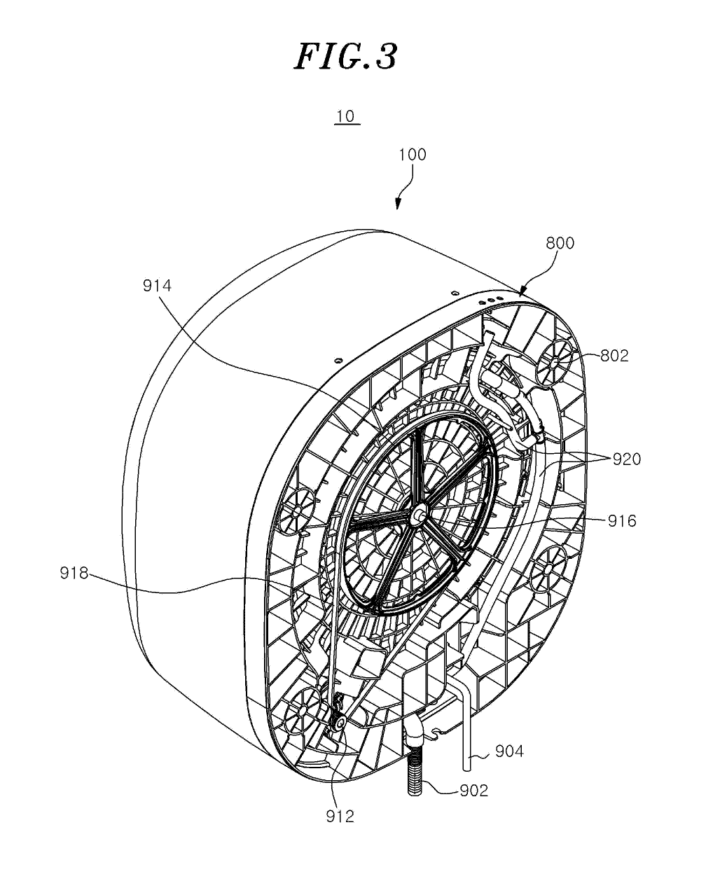

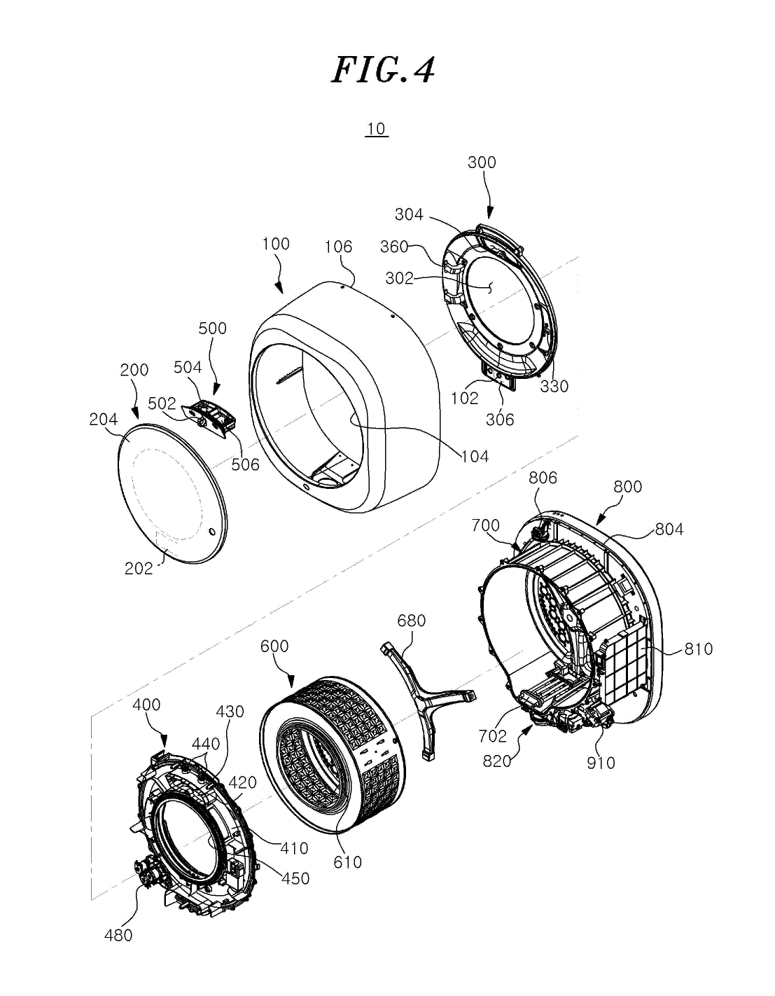

FIG. 1 is a perspective view showing the appearance of a wall mounted washing machine according to an embodiment of the present disclosure, FIG. 2 is a view showing a state in which the door of FIG. 1 is opened, FIG. 3 is a rear perspective view of the washing machine of FIG. 1, and FIG. 4 is an exploded perspective view of the washing machine of FIG. 1.

Referring to FIGS. 1 to 4, a wall-mounted washing machine 10 according to an embodiment of the present disclosure may include a cabinet 100 having a front surface and a rear surface opened and forming an outer appearance or exterior shape thereof, a door 200 disposed on one side of the cabinet 100 and for opening or closing the opened front surface of the cabinet 100, a cover 300 connected to the door 200 for opening and closing the door 200, a front panel 400 disposed on the rear surface of the cover 300, a detergent container 500 housed in one side of the front panel 400 and accommodating detergent and conditioner, a drum 600 in which laundry is stored, a tub 700 which surrounds the drum 600 and is filled with wash water, and a rear panel 800 mounted on the wall. Here, the rear surface means a surface close to the wall, and the front surface means a surface opposite to the rear surface.

Specifically, the cabinet 100 may be provided in an empty form. Also, the cabinet 100 may include a power button 102 for controlling a power supply, a cover connection unit 104 connected to the cover 300, and a rear panel connection unit 106 connected to the rear panel 800.

The power button 102 may be provided on one side of the cabinet 100 to control whether the washing machine 10 is turned on or off. The power button 102 may be provided on one side of the front surface of the cabinet 100 to be easily controlled by the user. Here, in this embodiment, the power button 102 is provided on the lower surface of the front surface of the cabinet 100. However, the position of the power button 102 is not limited thereto, and may be provided on the left or right of the front surface of the cabinet 100, for example, or in other well known positions.

The cabinet 100 may include a cover connection unit 104 connected to the cover 300. The cover connection unit 104 may correspond to an edge of the opened front surface of the cabinet 100 and may have a smaller diameter than the diameter of the cover 300 so that the cover 300 is not detached from the cabinet 100. Specifically, the cover 300 may be inserted into the cabinet 100 from the rear surface to the front surface side. In this case, since the diameter of the cover connection unit 104 is smaller than the diameter of the cover 300, the cover 300 may be fitted into the cover connection unit 104, so that the cover 300 may not be separated from the cabinet 100.

The cabinet 100 may include a rear panel connecting unit 106 connected to the rear panel 800. The rear panel connecting unit 106 may correspond to the opened rear edge of the cabinet 100 and may have a shape that corresponds to the shape of the rear panel 800. The cabinet 100 may be bolted to the rear panel 800 and for this purpose, a plurality of bolt fastening holes may be formed in the rear panel connecting portion 106

Meanwhile, the door 200 may be provided on the front surface of the cabinet 100. The door 200 is provided for loading and unloading laundry, and may include a door inner frame 230 and a door outer frame 240. Specifically, the door inner frame 230 and the door outer frame 240 may be bolted in such way to offer a predetermined space therebetween, and each may be provided in a circular shape having a diameter corresponding to the cover connection unit 104. In this case, the door inner frame 230 may be in contact with the cover connection unit 104, and the door inner frame 230 and the door outer frame 240 may completely shield the cover 300 connected to the cabinet 100.

The door inner frame 230 and the door outer frame 240 may include a door hinge connection unit 232 for connection with the cover 300. The door hinge connecting unit 232 is provided at one side of the door inner frame 230 and the door outer frame 240 and may provide a space for accommodating a door hinge 360 of the cover 300 to be described later.

A display 202 may be provided in a space between the door inner frame 230 and the door outer frame 240. The display 202 is capable of outputting predetermined information to the user, and is provided with a front surface exposed to the outside of the door outer frame 240. That is, the door outer frame 240 may include a hole (not shown) or may be formed of a transparent material so that the display 202 may be viewed. In this case, the display 202 may include a touch panel capable of inputting or outputting information, and the user may view the panel to confirm information such as the operating state through the display 202, and also use the panel to perform operations of the wall-mounted washing machine 10 via touch interactions. For example, the user may select a process such as washing and rinsing of the laundry by performing a touch interaction with respect to the display 202, and confirm the remaining washing time or the like through the display 202.

The display 202 exposed to the exterior of the door outer frame 240 and the door outer frame 240 may be protected through a protective glass 204. The protective glass 204 is transparently provided on the front surface of the door outer frame 240 so that the user may identify the display 202. In this case, the protective glass 204 may be provided with the same diameter as the door inner frame 230 and the door outer frame 240.

A hole (not shown) may be provided on one side of the protective glass 204, and the door opening button 210 may be exposed to the outside through the hole (not shown). The door opening button 210 may be provided in the door outer frame 240 for opening or closing the interior of the cabinet 100 using an electronic opening and closing system and may be exposed to the outside through a hole of the protective glass 204.

In addition, the door 200 may include a door opening unit 250 and a door hanging unit 260. The door opening unit 250 and the door hanging unit 260 may protrude rearward of the door inner frame 230 and may be in contact with and engaged with one side of the cover 300. Specifically, the door opening unit 250 serves as an opening/closing assistant and may have an elastic force. For example, the door opening unit 250 may include a spring and may act as a support for opening the door 200 through the elastic force of the spring. For example, when the door 200 is closed, the door opening unit 250 may be compressed and inserted into a groove (not shown) provided on one side of the cover 300. When the user operates the door opening button 210 to open the door 200, the door opening unit 250 may be released from one side of the cover 300, and may be in contact with the bottom surface of the groove (not shown) provided on one side of the cover 300 in a relaxed state. That is, a space is provided between the door 200 and the cover 300 by the relaxed length of the door opening unit 250, thereby preventing the door 200 from being automatically closed.

The door opening unit 250 may be a pusher stem assembly that may be supported by the spring and located within a guide structure formed in the door inner frame 230 or repeatedly perform projecting by a linear movement through a predetermined stroke range.

The door hanging unit 260 may be provided at a predetermined distance from the door opening unit 250 and may be provided in the shape of a hook partially protruding from the door inner frame 230. The protruding portion of the door hanging unit 260 may be coupled to a door lock unit 330 of the cover 300 to be described later, and thus the door 200 may be closed.

In summary, the door 200 according to one embodiment of the present disclosure may be opened through a door opening button 210. When the user operates the door opening button 210, the door opening unit 250 and the door hanging unit 260 may be released from the cover 300 so that the door 200 may open the cover 300. In this case, the door opening unit 250 having an elastic force may be relaxed and provided on one side of the cover 300, and thus a predetermined gap is provided between the door 200 and the cover 300. Therefore the door 200 may be prevented from closing.

In addition, the user may close the door 200 by applying pressure to the door 200 toward the cover 300 side. To this end, the user may press one side of the outermost protective glass 204 of the door 200 so that the door opening unit 250 may be compressed and become received in the groove (not shown) of the cover 300 and the protruding portion of the door hanging unit 260 may be coupled to the door hanging unit 330 of the cover 300. That is, the door 200 may be opened and closed without a separate handle.

A center side of the door inner frame 230 and the door outer frame 240 may be opened and the door glass 280 may be provided at the opened center side. The door glass 280 allows the user to view the laundry inside the machine from the outside of the washing machine 10 and may be fitted to the door inner frame 230 and the door outer frame 240. In this case, the door glass 280 may be formed to protrude rearward, and the protruded side of the door glass 280 may be fitted to the opened side of the cover 300.

Meanwhile, the door 200 may be rotatably connected to the cover 300. The cover 300 is provided to enclose the front panel 400 and may include a laundry inlet 302 for loading the laundry, a detergent container loading port 304 for loading a detergent container 500, and a power processing unit 306 for controlling the button 102.

The user may load laundry through the laundry inlet 302. The laundry inlet 302 may be provided to have a predetermined diameter. In this case, the diameter of the laundry inlet 302 may correspond to the size of the protruding portion of the door glass 280. Thus, when the door 200 is closed, the door glass 280 may block the laundry inlet 302, and when the user opens the door 200, the door glass 280 is released from the laundry inlet 302 to allow laundry loading through the laundry inlet 302.

A detergent container loading port 304, which may load the detergent container 500, may be provided on the upper side of the laundry inlet 302. In this case, the detergent container loading port 304 may correspond to the shape of the detergent container 500.

The cover 300 may have a laundry inlet 302 at its center and may have a circular shape as a whole. Further, the cover 300 may be shaped such that one side protrudes downward. In this case, the power processing unit 306 may be provided in a protruding portion downward. The power processing unit 306 may be a PCB substrate connected to the power button 102 to control whether the power is turned on or off according to the operation of the power button 102 protruding from the outside of the case 100.

Meanwhile, the cover 300 may include a door hanging unit 330 located at a position corresponding to the other door hanging unit 260. The door hanging unit 330 is coupled to the hook-shaped door hanging unit 260 and may include a groove corresponding to the shape of the door hanging unit 260. Thus, as the door hanging unit 260 is coupled to the other door hanging unit 330, so that the door 200 may close the laundry inlet 302.

Also, the cover 300 may include a door hinge 360 at a location corresponding to the door hinge connection unit 232. The door hinge 360 may be opened while one side of the door 200 and one side of the cover 300 may be connected to each other, and the one side of the door hinge 360 may be received in the door hinge connection unit 232. Specifically, the door hinge 360 may be formed in a shape of a long curved panel in a vertical direction on one side of the laundry inlet 302, and may be partially protruded forward such that the door 200 may be rotated and connected to the door hinge connection unit 232. That is, the door 200 may be rotatable along the protruding portion in front of the door hinge 360.

Meanwhile, a front panel 400 may be provided on the rear surface of the cover 300. The front panel 400 may be coupled to the tub 700 and may include a shield unit 410 shielding a space between the drum 600 and the tub 700, a detergent container receiving unit 420 receiving the detergent container 500, a detergent container gasket 430 which provides a seal at a portion coupled with the detergent container 500, a fitting 440 for supplying water into the detergent container 500, a door gasket 450 which provides a seal at a portion in contact with the door 200, and a water supply valve assembly 480 for receiving wash water from an external water supplying source.

The shield unit 410 may shield a space generated between the drum 600 and the tub 700 and may have a shape corresponding to the shape of the cover 300. That is, it may have the same diameter as the cover 300 and have an opening corresponding to the laundry inlet 302 provided on the center side thereof. In this regard, the opening of the shield unit 410 may Lie smaller than the diameter of the drum 600, so that the space between the drum 600 and the tub 700 may be shielded.

The detergent container receiving unit 420 may be provided at one side of the shield unit 410 to receive the detergent container 500. The detergent container receiving unit 420 may have a shape corresponding to the shape of the detergent container 500 and may be in communication with the detergent container loading port 304 of the cover 300. That is, the detergent container 500 may be received in the detergent container receiving unit 420 via the detergent container loading port 304 of the cover 300.

The detergent container receiving unit 420 may include a detergent container gasket 430 that is pressurized by the detergent container 500. The detergent container gasket 430 may be disposed around the end of the detergent container receiving unit 420 to seal the detergent container 500 and may be composed of a rubber material. That is, the detergent, the conditioner, and the wash water supplied to the detergent container 500 are prevented from leaking to the outside through the detergent container gasket 430.

At least one fitting 440 may be provided on the top of the detergent container receiving unit 420. The fitting 440, which is connected to a water supply valve assembly 480 connected to an external water supply source, may supply the wash water into the detergent container 500. Thus, the wash water supplied to the drum 600 and the tub 700 may include the dissolved detergent or conditioner because the wash water is supplied into the drum 600 and the tub 700 through the detergent container 500.

Meanwhile, the opening of the shield unit 410 may include a door gasket 450 which is pressed by a door glass 280 of the door 200. The door gasket 450 may be disposed at the opening end of the shield unit 410 (for example, at the annular end of the opening) to hermetically fix the door glass 280, and it may be composed of a rubber material or the like. Thus, when the door 200 is closed, the door glass 280 penetrating the laundry inlet 302 of the cover 300 presses the door gasket 450, and therefore the wash water inside the drum 600 and the tub 700 will not leak outside the door 200.

The fitting 440 may be supplied with wash water through a water supply valve assembly 480. The water supply valve assembly 480 may be connected to an external water supply source and may selectively supply the wash water to the detergent container 550 through the fitting 440. The water supply valve assembly 480 may be a three-way valve and two of the supply flow paths extending from the water supply valve assembly 480 may be connected to the fitting 440 connected to the detergent container 500 and one of them may supply the wash water to the drum 600 directly through the door gasket 450.

The detergent container 500 may accommodate detergent and conditioner and may include a detergent container handle 502, a detergent input space 504 in which detergent is loaded, and a conditioner input space 506 in which a conditioner is loaded.

The detergent container handle 502 may protrude forward and may be exposed to the outside of the cover 300. The user thus may grasp the detergent container handle 502 after opening the door 200, allowing the detergent container 500 to be unloaded or inserted from the detergent container receiving unit 420. In this embodiment, although the detergent container handle 502 is extended in the vertical direction and provided at the center of the front surface of the detergent container 500, the detergent container handle 502 is not limited thereto. For example, the detergent container receiving unit 420 may be extended in the horizontal direction and provided on the front surface of the detergent container 500.

The detergent container 500 may be partitioned based on the center of the interior and include a detergent input space 504 and a conditioner input space 506 which may contain detergent and conditioner, respectively. In this connection, the fitting 440 may be arranged to correspond with the detergent input space 504 and the conditioner input space 506, and the detergent and conditioner in the detergent input space 504 and the conditioner input space 506 may be supplied with the wash water. Specifically, the user may draw the detergent container 500 from the detergent container receiving unit 420 after opening the door 200 and may fill detergent and conditioner into the detergent input space 504 and the conditioner input space 506, respectively. The detergent container 500 filled with the detergent and the conditioner may be inserted again into the detergent container receiving unit 420, and depending on the washing process, the detergent input space 504 and the conditioner input space 506 may be supplied with the wash water. Accordingly, the wash water including detergent or conditioner may be selectively supplied to the drum 600 and the tub 700.

Meanwhile, the front panel 400 may be connected to the drum 600. The drum 600 for receiving the laundry may include a drum inlet portion 610 on the front surface and a spider 680 on the rear surface. In this case, a plurality of holes may be formed around the drum 600 for fluid communication with the tub 700.

A drum inlet portion 610 may correspond to the opened portion of the shield unit 410. In this regard, the drum inlet portion 610 may have a diameter smaller than the entire diameter of the drum 600, and the drum inlet portion 610 may be fitted into the opened portion of the shield unit 410, so that front panel 400 and the drum 600 may be connected to each other. Thus, the laundry may be loaded into the drum 600 via the laundry inlet 302 of the cover 300 and the opened portion of the front panel 400.

The drum 600 may be rotated through a spider 680. The spider 680 may rotate in response to a driving force from a driving motor 910 (to be described later). The spider 680 may be separate from the drum 600 and also coupled to the rear surface of the drum 600. In this case, a groove corresponding to the shape of the spider 680 may be formed on the rear surface of the drum 600 so that the spider 680 may be seated.

The spider 680 may include a plurality of arms extending in different directions with a constant gap at the center. For example, the spider 680 may include an arm extending in three directions by a length corresponding to the radius of the drum 600, and each arm may be disposed at a 120-degree gap. Further, the center of the spider 680 may be fixed to a second pulley 914 (to be described later) through a drum rotation axis 916 to be described later, and thus both the drum 600 coupled to the spider 680 and the spider 680 may be rotated. A specific method of rotating the drum 600 will be described later.

A tub 700 in which the wash water is filled may be provided outside the drum 600. The tub 700 may have a shape corresponding to the drum 600 and may be formed with a diameter larger than a diameter of the drum 600 by a predetermined length. Accordingly, the tub 700 may be arranged apart from the drum 600 by a predetermined gap. In addition, the wash water supplied into the tub 700 may flow into the drum 600 through a plurality of holes formed around the drum 600. Similarly, the inner wash water of the drum 600 may flow into the tub 700 through the plurality of holes formed around the drum 600. In this regard, the drum 600 and the tub 700 may be provided in a cylindrical shape, but of course are not limited thereto.

Further, the tub 700 may include a heater 702 to heat the wash water. Specifically, a groove may be formed on the inner side of the tub 700 to receive the heater 702, and a heater 702 may be provided on the inner side of the tub 700 in a detachable manner. Thus, the heater 702 may heat the wash water filled in the tub 700.

Meanwhile, the tub 700 may be integrally provided with a rear panel 800. The rear panel 800 may be mounted on the wall and may include an anchor connection unit 802 to which an anchor (for mounting to the wall) is connected, a cabinet fixing unit 804 for fixing the cabinet 100, and a sensor 806 for detecting the water level.

Specifically, the tub 700 and the rear panel 800 may be integrally injection molded, and the tub 700 may protrude from the front of the rear panel 800. The rear surface of the rear panel 800 may be mounted on the wall via a separate anchor. The anchor may be coupled to the wall through an anchor connection unit 802 and may be provided on the rear surface of the rear panel 800 for stable engagement. That is, the plurality of anchors may mount the rear panel 800 on the wall. In this case, since the tub 700 and the rear panel 800 are integrally provided, a separate damper or an elastic member for supporting the tub 700 is not required. Consequently, the number of parts may be reduced, and the size of the washing machine 10 may be likewise reduced.

The cabinet 100 may be coupled to the front surface of the rear panel 800 where the tub 700 is provided to enclose the tub 700. In this case, a cabinet fixing unit 804 may be provided to have a stepped shape along the periphery of the rear panel 800, and the cabinet 100 may be fixed to the cabinet fixing unit 804. For this purpose, a fastening member such as a bolt may be used.

Also, the rear panel 800 may include a control unit 810 for controlling the overall functions of the wall mounted washing machine 10 and a drain unit 820 for discharging the wash water filled in the tub 700.

The control unit 810 may be provided on the front surface of the rear panel 800 to control various components of the wall mounted washing machine 10 depending on a user's operation to perform laundry washing. In this embodiment, while the control unit 810 is shown on the right side of the respect to tub 700, the position of the control unit 810 is not limited thereto.

A power supply line 904 may be connected to the external power source to supply power to the electric equipment, the control unit 810, the driving motor 910, and the like described above. The power supply line 904 may extend through the rear panel 800 to the front of the rear panel 800 and may extend outwardly from the rear of the rear panel 800. In this case, the power supply line 904 may be fixed to the rear surface of the rear panel 800 through a separate fixing means. As the power supply line 904 is provided extending outwardly from the rear surface of the rear panel 800, the washing machine 10 may have a finished or pleasing appearance.

The drain unit 820 may be provided under the rear panel 800. The drain unit 820 may discharge any wash water inside the tub 700 to the outside and may be disposed on the lower surface of the front surface of the rear panel 800. In this case, the drain unit 820 may include a drain pump for pressurizing the wash water and may be connected to the drain hose 902 to discharge the wash water. Specifically, the drain hose 902 is connected to the drain unit 820 and extends outward along the rear surface of the rear panel 800, so that the wash water may flow through the pressure of the drain unit 820. Thus, when the drain unit 820 is operated after the washing cycle is completed, the wash water may be discharged to the outside of the cabinet 100 through the drain hose 902 under the pressure change of the drain unit 820.

Meanwhile, the rear panel 800 may include a driving motor 910 for transmitting a driving force to the rear panel 800, a first pulley 912 and a second pulley 914 connected to the driving motor 910, a drum rotational shaft 916 connected to the second pulley 914 to rotate the drum 600, and a belt 918 that connects the first pulley 912 and the second pulley 914.

Specifically, the driving motor 910 may be provided on the front surface of the rear panel 800. The driving motor 910 may be controlled by the control unit 810 and may be provided on one side of the control unit 810 and the drain unit 820.

Also, the driving motor 910 may be connected to the first pulley 912. In this case, the shaft (not shown) of the driving motor 910 may be provided through the rear panel 800 and may be connected with a shaft (not shown) of the driving motor 910 to the first pulley 912 at the rear surface of the rear panel 800.

The first pulley 912 may be connected to the second pulley 914 via a belt 918. The second pulley 914 may be provided to surround the drum rotation shaft 916 connected to the spider 680 and the drum rotation axis 916 may penetrate the rear panel 800 while being connected to the spider 680. That is, the second pulley 914 and the drum rotation shaft 916 may be connected to each other at the rear surface of the rear panel 800.

In summary, when the wash water is filled in the tub 700 through the fitting 440, the control unit 810 may operate the driving motor 910. Subsequently, the first pulley 912 connected to the driving motor 910 may be rotated, and the second pulley 914 may be then rotated by the rotation of the first pulley 912. Thus, the drum rotation shaft 916 connected to the second pulley 914 may also rotate so that the drum 600 may be rotated inside the cabinet 100 and the tub 700. Consequently, the laundry inside the drum 600 may be washed.

On the other hand, the rear panel 800 may further include an exhaust line 920. The exhaust line 920 may be connected to the drain unit 820 and may exhaust air inside the tub 700 and the drain unit 820. Specifically, the exhaust line 920 may be connected to the drain hose 902 and pass through the rear panel 800, through which it may extend to the rear surface of the rear panel 800 and be exhausted to the outside.

The wall-mounted washing machine 10 according to an embodiment of the present disclosure may be used as follows.

First, the user may open the door 200, and may load the laundry inside the drum 600 and unload the detergent container 500 from the front panel 400. In this case, the detergent container 500 is divided in the center, so that a space for loading detergent and conditioner, respectively, may be provided.

After inserting the detergent container 500 loaded with the detergent and conditioner back into the front panel 400, the user may close the door 200 and control the laundry operation via the power button 102 and the display 202. When the washing cycle is started, the wash water provided from an external water supplying source through the water supply valve assembly 480 may be supplied to the detergent container 500 through the fitting 440, and the wash water may be supplied into the drum 600 and tub 700 after passing the detergent input space 504 and the conditioner input space 506. That is, the wash water filled in the drum 600 and the tub 700 may optionally include detergent and conditioner.

When the tub 700 is fully filed with the wash water, the control unit 810 may drive the driving motor 910. In this case, the driving motor 910 may be connected to the first pulley 912 and the second pulley 914, and the second pulley 914 may be connected to the drum 600 through the drum rotation shaft 916. Thus, the drum 600 may be rotated through the driving motor 910. Consequently, the laundry loaded in the drum 600 may be easily washed by the rotation of the drum 600.

When the door 200 is closed, the door 200 may rotate toward the cover 300, and when the door 200 is opened, the door 200 may be reversely rotate away from the cover 300.

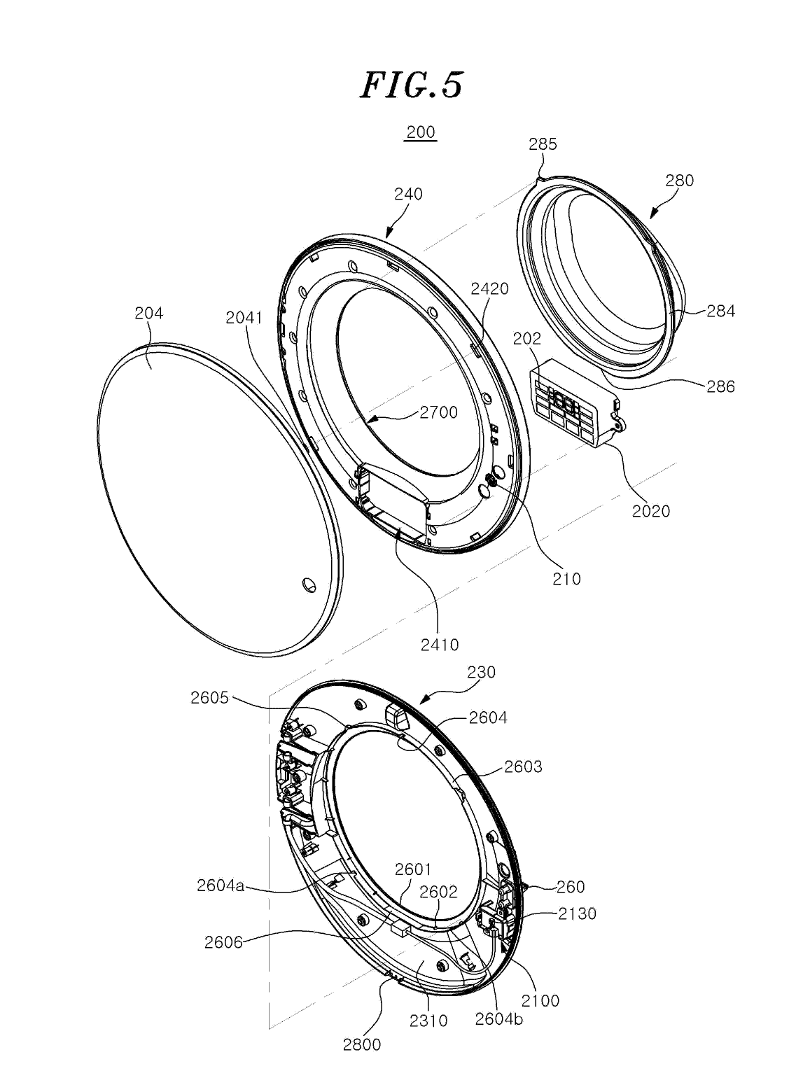

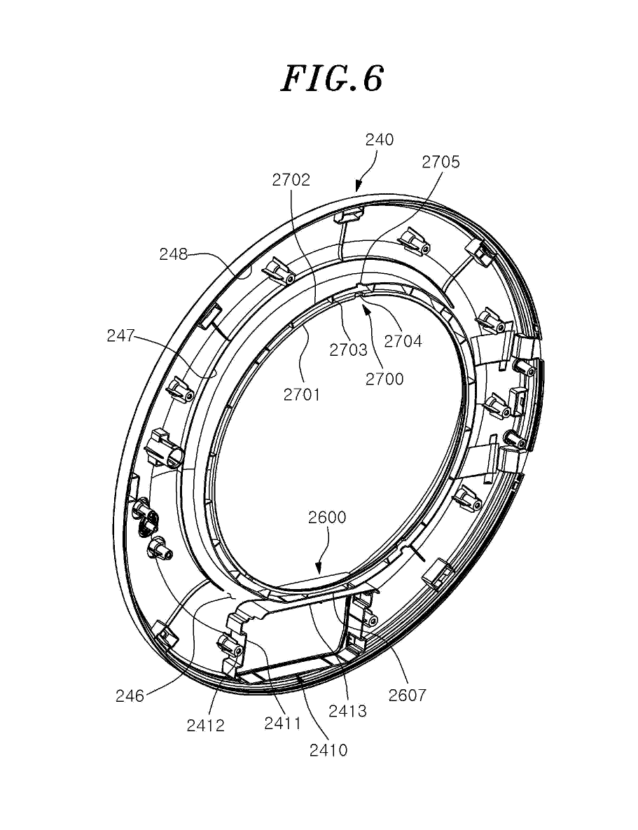

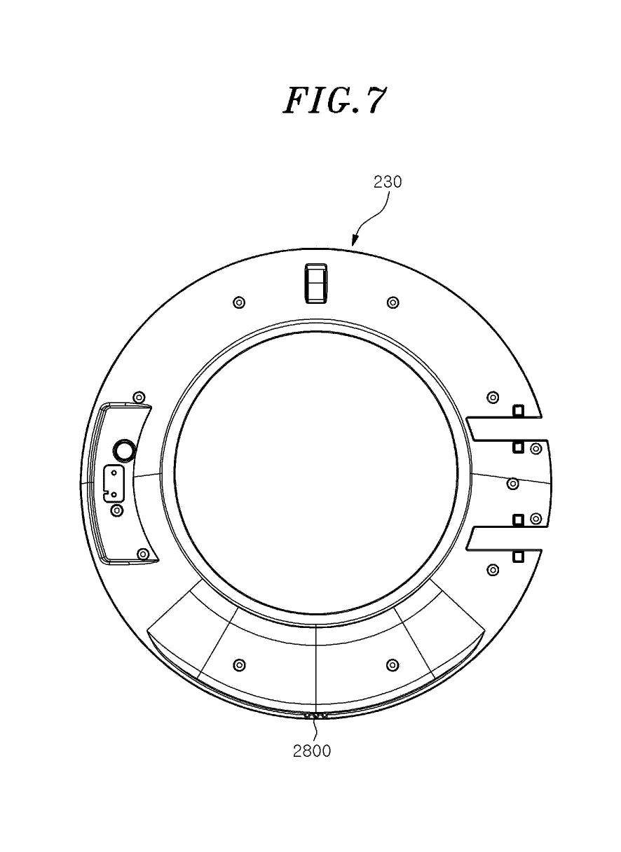

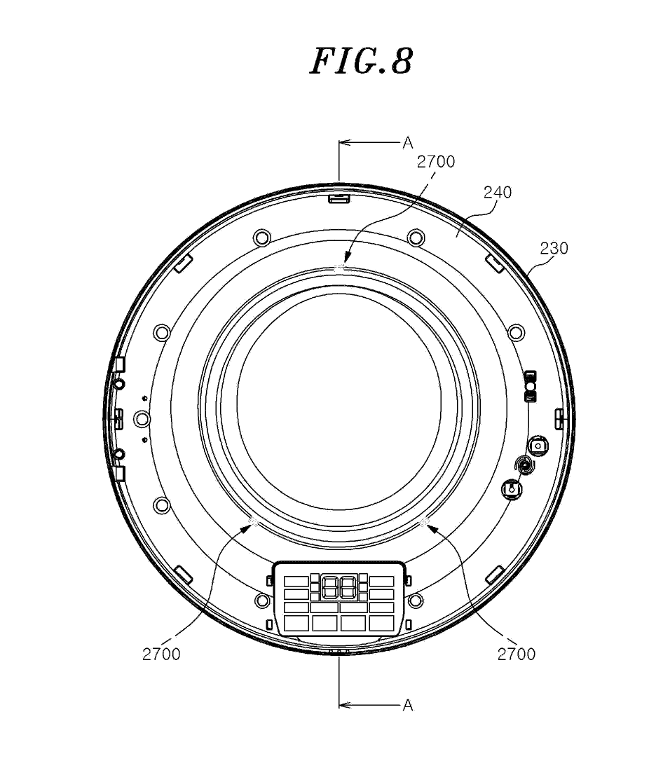

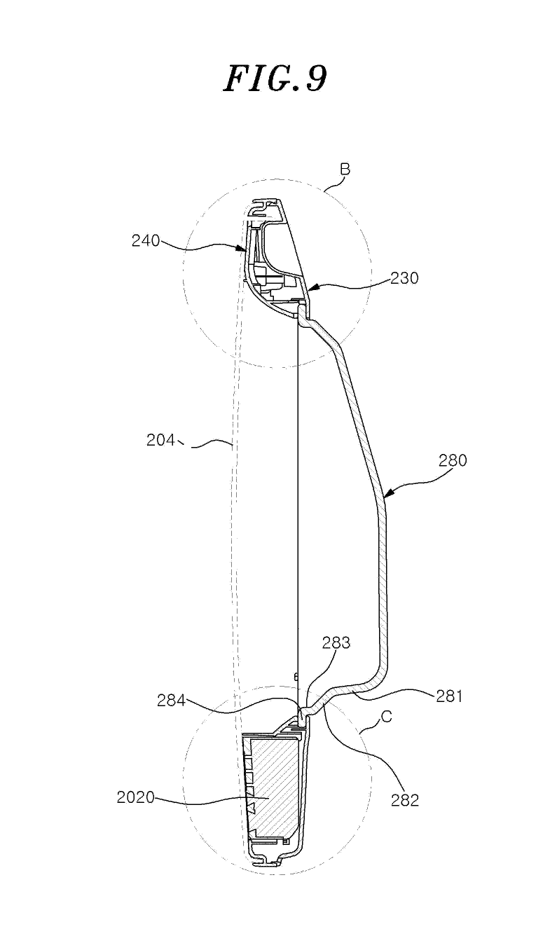

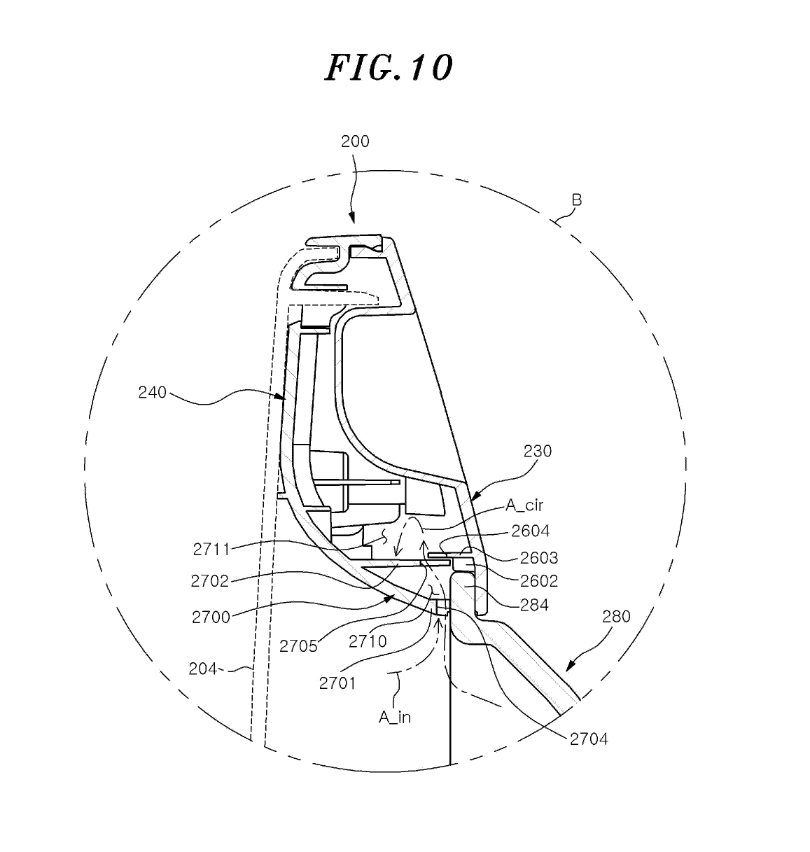

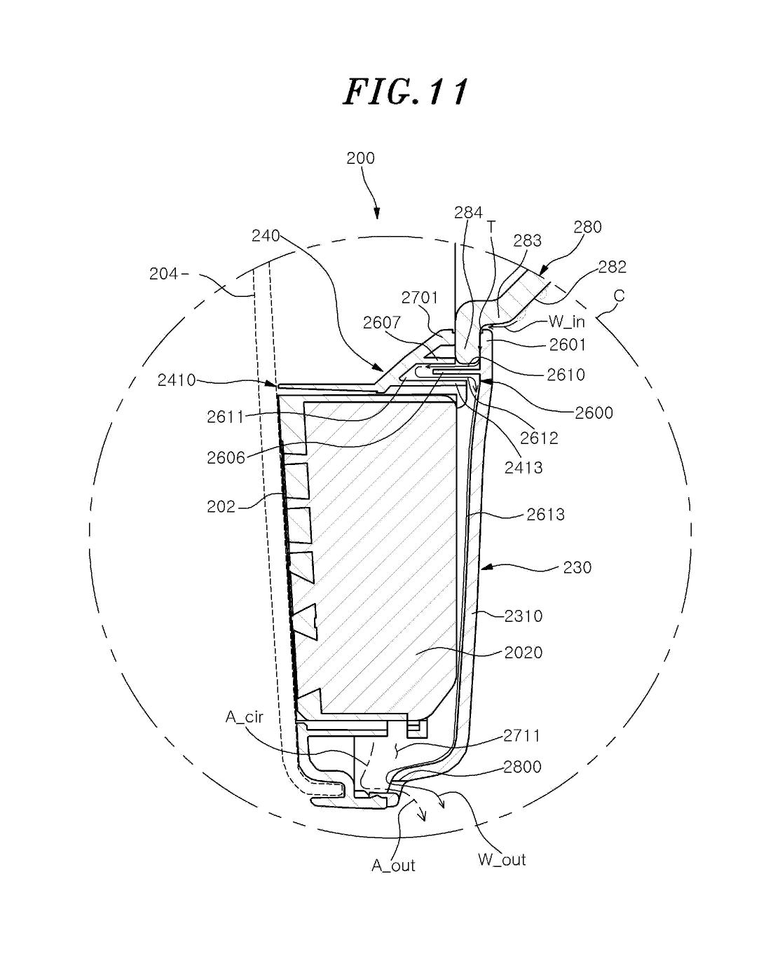

FIG. 5 is an exploded perspective view of the door shown in FIG. 4, FIG. 6 is a perspective view showing the inner side of the door outer frame shown in FIG. 5, FIG. 7 is a rear view showing the outer side of the door inner frame shown in FIG. 5, FIG. 8 is a front view of an assembly of a door except for the protective glass in FIG. 5, FIG. 9 is a cross-sectional view taken along the line A-A in FIG. 8, FIG. 10 is an enlarged view of a circle B in FIG. 9, and FIG. 11 is an enlarged view of a circle C in FIG. 9.

Referring to FIGS. 5 to 11, the door 200 is rotatably coupled to the door hinge 360 of the cover 300 shown in FIG. 4. The door 200 may also be a disk-like structure or assembly having a circuit 2020 for driving the display 202 located in the door 200 with respect to a lower position of the door glass 280, for instance. Further, the door 200 may be a central protruding structure in which the thickness of the outer portion of the door 200 is thin and the thickness of the door 200 gradually increases toward the central portion of the door 200.

The wall mounted washing machine includes a door opening and closing device which can be, in one embodiment, an electronic opening and closing type device and provided or disposed on the door 200.

It is appreciated that in one embodiment, therefore, the door opening and closing device is an electronic device capable of opening the door 200.

For example, the door opening and closing device refers to a means by which a user may open the door 200 by pressing the opening button 210 of the door 200 with a user's finger. To this end, a contact switch 2130 of an opening button circuit module 2100 linked to the opening button 210 performs the ON or OFF operation so that the door locking unit 330 of the cover 300 of FIG. 4 may selectively lock or unlock the door hanging unit 260 of the door 200.

In addition, the wall mounted washing machine includes a circuit 2020 for driving the display 202 which is disposed within the door 200, protected by a protective glass 204 and installed, e.g., below, the door glass 280, in one embodiment.

The circuit 2020 for driving the display 202 may exert a watertight seal by a molding part (not shown) processed outside thereof. However, the circuit 2020 for the display 202 may potentially malfunction or fail due to excessive moisture or water contacting therewith.

Therefore, in this embodiment, a drainage means may be provided. The drainage means prevents water from penetrating into the door 200 during a performance test cycle such as an injection test or a cleaning cycle of the washing machine. In addition, even if a small amount of water flows into the door 200, the drainage means advantageously discharges the small amount of water to the outside of the door 200 without water being accumulated in the door 200. For example, the drainage means may be a trap portion 2600 as described later.

In addition, in this embodiment, a moisture preventing means may be provided. The moisture-preventing means is capable of smoothly discharging the moisture that may be generated by the temperature difference or the pressure difference corresponding to the environmental difference to the outside of the door 200 so that the wall-mounted washing machine may exhibit robust safety. In addition, the moisture preventing means is provided to mutually expose moisture inside the door 200 and dry air outside the door 200 to perform heat exchange by convection. For example, the moisture preventing means may comprise a number of gas passage portions 2700 described later. Here, the temperature difference may include a difference between the temperature of the door glass 280 cooled by direct contact with the cold water and the temperature of the inner space of the door 200.

The gas passage portions 2700 included in the door 200 are installed in the vicinity of the door glass 280 with respect to a predetermined point that does not interfere with an installation position of the trap portion 2600, by considering a path into which water hardly flows.

It is appreciated that the gas passage portions 2700 interconnect the inner space of the door glass 280 and the inner space of the door 200, and serve to generate or induce gas convection in each space.

The door 200 includes a door inner frame 230 and a door outer frame 240 that are configured to be separated or assembled as described above. The door 200 may be an assembly in which the inner frame 230 and the door outer frame 240 are assembled.

Even if the door opening button 210 is simply pressed by the user's finger, the lock state of the door 200 may be released, thereby maximizing user's convenience. In addition, the door opening and closing device is a means by which the door 200 may be advantageously opened easily and quickly.

The door hanging unit 260 is made of a metal material having more structural strength than that of the door 200, and is detachably attached by a fastening means such as a bolt.

The material that composes the door 200 may be an engineering plastic material or a synthetic resin.

The door hanging unit 260 is mounted on the door 200 and may be a (e.g., locking) component coupled to the door locking unit 330 of FIG. 4 or may be a (e.g., unlocking) component unlocking from the door locking unit 330.

The door locking unit 330 may be a device capable of selectively locking or unlocking the door hanging unit 260 using an elastic force and an electromagnetic force, for instance.

A protective glass 204 is coupled to the outside of the outer frame 240. For example, the protective glass 204 may be formed with a plurality of fastening portions 2041 protruding toward the door outer frame 240. In addition, the door outer frame 240 is formed with hole-like elastic hooking step portions 2420 into which the fastening parts 2041 may be inserted. Since hooking steps of the “free end” type capable of being deformed within the elastic range are formed in the elastic step portions 2420, the hooking steps may be engaged with fastening holes (not shown) of the fastening portions 2041.

The door glass 280 is supported on the door inner frame 230 and the door outer frame 240 which are coupled to each other.

The trap portion 2600 included in the door 200 may be disposed around the door glass 280 in consideration of the infiltration path of the water. The trap portion 2600 may be disposed below the door glass 280 or above the circuit 2020 for the display 202 to prevent water from flowing into the circuit 2020. For example, the trap portion 2600 may be provided with respect to a position between the door glass 280 and the circuit 2020, or on the lower side of the door glass 280. In one example, this trap portion 2600 may be defined or formed when the door inner frame 230 and the door outer frame 240 are assembled together.

The trap portion 2600 guides the flow of a flowable fluid, e.g., water or wash water, through a gap T (e.g., see FIG. 11) located between the door glass 280 and the door inner frame 230.

In addition, the trap portion 2600 may define a flow path of a fluid, for example, liquid or gas, from a gap T between the door glass 280 and the door inner frame 230 to a fluid outlet 2800 of the door inner frame 230 shown in FIG. 7.

As shown in FIG. 5, the door glass 280 is easily assembled with the door inner frame 230 and includes means for preventing errors in the assembly direction.

For example, the door glass 280 may include a plurality of positioning protrusions 285 disposed and spaced apart from both sides of the upper portion of the glass edge portion 284.

In addition, the door glass 280 includes a flat portion 286 provided on the lower side of the glass edge portion 284.

The glass edge portion 284 has a curved shape extending along the circumferential direction of the door glass 280 with respect to the front surface of the door glass 280 except for the flat portion 286 and the positioning protrusions 285.

The flat portion 286 of the glass edge portion 284 may be in surface contact with the reference surface when the door glass 280 is transported or installed, and thus identification of the assembly direction and position of the door glass 280 may be facilitated. Further, the door glass 280 may be erected vertically at the reference surface by the flat portion 286, and the door glass 280 may be easily assembled and stored as a whole.

In addition, as shown in FIG. 9, the door glass 280 includes a cap-shaped glass body 281 having a vertically asymmetric cross section and bulged toward the drum 600 of FIG. 4.

The door glass 280 includes a glass inclined portion 282 in which the outer diameter of the door glass 280 is gradually expanded from the glass body 281 toward the door inner frame 230.

In addition, the door glass 280 includes a glass extension portion 283 extending in a direction from the end of the glass inclined portion 282 toward the door inner frame 230 and a glass edge portion 284 bent from the end of the glass extension portion 283 in an outward direction perpendicular to the extending direction of the glass edge portion 283.

In the glass inclined portion 282, water droplets “W_in” are present during washing machine operation, washing machine cleansing, or washing machine water supply, so that the water droplets W_in may flow toward the gap T along the surface of the glass inclined portion 282 and the surface of the periphery thereof by the weight of the water.

More specifically, the gap T may be formed between the outer side of the glass edge portion 284 of the door glass 280 and the inner side of an inner frame hole portion 2601 of the door inner frame 230 and may be an opening that extends downwardly.

A fluid such as the water droplets W_in or other water may penetrate from the glass inclined portion 282 to the gap T via the glass extension portion 283 due to a fluid force or surface tension when descending along the surface of the door glass 280.

The door outer frame 240 includes outer frame hole portions 2701, an outer frame hole reinforcing portion 2702, connecting ribs 2703, first passage groove portions 2704 and second passage groove portions 2705.

The door inner frame 230 may include the inner frame hole portion 2601, support ribs 2602, a wall body 2603, third passage groove portions 2604, positioning groove portions 2605 and a first guide wall 2606.

The inner frame hole portion 2601 of the door inner frame 230 is open in the thickness direction from the center of the door inner frame 230 to mount the door glass 280.

The support ribs 2602 are formed to protrude from the inner side of the inner frame hole portion 2601 and are spaced apart from each other along the circumferential direction of the inner frame hole portion 2601. The support ribs 2602 may be composed of multiple support ribs configured to support a glass edge portion 284 of the door glass 280 in a radial direction of the door 200.

Since the support ribs 2602 are in line contact with the glass edge portion 284, the assembly process may be relatively easy compared to the surface contact. For example, the assembly by surface contact may be influenced not only by the assembling position but also by the assembling direction. However, since point contact or line contact are possible in this embodiment, the assembly process between the door glass 280 and the door inner frame 230 may be facilitated even if there is some deviation in the assembling direction.

The wall body 2603 extends along the circumferential direction of the door inner frame 230 from the inner side of the inner frame hole portion 2601 to connect the support ribs 2602 to each other. The support ribs 2602 may be integrally formed at the corner between the wall body 2603 and the inner frame hole portion 2601, for instance.

The wall body 2603 may be a closed loop wall structure that may be formed and combined such that it corresponds to the shape of the glass edge portion 284 of the door glass 280.

The wall body 2603 is relatively more protruded from the inner sides of the inner frame hole portion 2601 than the protrusion height of the support ribs 2602.

The third passage groove portions 2604 are formed on the end of the wall body 2603 with respect to positions corresponding to the first passage groove portions 2704 or the second passage groove portions 2705 of the door outer frame 240 to form gas passage portions 2700. For example, the number of the third passage groove portions 2604 may be equal to the number of the gas passage portions 2700. The uppermost one of the third passage groove portions 2604 may be formed on the end of the wall body 2603 with respect to an intermediate point between the positioning groove portions 2605.

In addition, the other two third passage groove portions 2604a and 2604b are formed on the respective ends of the wall body 2603 with respect to points spaced from both sides of the first guide wall 2606.

The positioning groove portions 2605 may be formed and combined on the positioning protrusions 285 of the glass edge portion 284. The positioning groove portions 2605 are provided or formed spaced apart from the upper portion of the wall body 2603 to correspond with the positioning protrusions 285, respectively.

The first guide wall 2606 is integrally provided on the lower side of the wall body 2603 to not be in contact therewith by corresponding to the flat portion 286 of the glass edge portion 284.

In this case, the first guide wall 2606 is spaced below the gap T between the door glass 280 and the door inner frame 230 and serves as a partition for converting or circulating the vertical flow of the fluid leaking through the gap T into the horizontal flow. That is, in operation, the vertical descending flow of fluid leaking through the gap T may be limited by the first guide wall 2606.

The outer frame hole portions 2701 of the door outer frame 240 shown in FIG. 6 or FIG. 10 are open in the thickness direction from the center of the door outer frame 240 to mount with the door glass 280. The outer frame hole portions 2701 are in contact with the glass edge portion 284 to support the inner side of the glass edge portion 284 in the thickness direction of the door 200.

The outer frame hole reinforcing portion 2702 may be spaced apart from an outside of the outer frame hole portions 2701 and may be a double wall structure together with the outer frame hole portions 2701.

A plurality of connecting ribs 2703 connects the outer frame hole portions 2701 and the outer frame hole reinforcing portion 2702 to each other to increase the strength of the double wall structure.

The first passage groove portion 2704 is formed on the end of the outer frame hole portion 2701 with respect to a position on which the connecting ribs 2703 are not formed and serves as a passage for gas-to-air convection.

The second passage groove portion 2705 is formed on the end of the outer frame hole reinforcing portion 2702 with respect to a position corresponding to the first passage groove portion 2704.

The outer frame hole reinforcing portion 2702 of the door outer frame 240 shown in FIG. 6 or FIG. 11 is integrally formed in the inner frame hole reinforcing portion 2702 to serve as gas passage portions 2700, and includes a second guide wall 2607 having a one-piece shape or a horizontal wall shape.

That is, the second guide wall 2607 is integrally disposed on the lower side of the outer frame hole reinforcing portion 2702. In this case, the second guide wall 2607 is spaced apart from and parallel to the first guide wall 2606 from a position above the first guide wall 2606 of the door inner frame 230.

The door outer frame 240 is spaced from the lower side of the outer frame hole reinforcing portion 2702 and includes circuit receiving portion 2410 which is integrally formed on the inner side of the door outer frame 240 to receive the circuit 2020 for driving the display 202.

The circuit receiving portion 2410 protrudes from the inner side of the door outer frame 240 toward the door inner frame 230 and serves to receive the circuit 2020.

In addition, the circuit receiving portion 2410 includes a receiving wall body 2411 and screw supports 2412.

The receiving wall body 2411 protrudes from the inner side of the door outer frame 240 corresponding to the outside of the circuit 2020 to accommodate the circuit 2020, and is open in the front-rear direction for mounting the circuit 2020.

In particular, the upper end 2413 of the circuit receiving portion 2410 may correspond to the upper portion of the receiving wall body 2411 in the form of a straight or horizontal wall to be parallel to the second guide wall 2607. The upper end 2413 of such a circuit receiving portion 2410 forms part of the fluid flow path for the trap portion 2600. The screw supports 2412 are disposed on both sides of the receiving wall body 2411 and are integrally formed on the inner side of the door outer frame 240. The screw supports 2412 are used for screw or bolt connecting between the door outer frame 240 and the door inner frame 230.

Further, the front surface of the circuit receiving portion 2410 may be covered by the protective glass 204 and covered by the circuit protection portion 2310 of the door inner frame 230 of the circuit receiving portion 2410.

As such, the circuit receiving portion 2410 is surrounded by the receiving wall body 2411 and closed by the protective glass 204 or the circuit protection portion 2310.

The circuit protection portion 2310 is formed integrally with the door inner frame 230 to correspond to the shape of the circuit receiving portion 2410 to cover the rear surface of the circuit receiving portion 2410.

The first guide wall 2606 of the wall body 2603 of the door inner frame 230 at the door 200 is inserted into a space between the upper end 2413 of the circuit receiving portion 2410 of the door outer frame 240 and the second guide wall 2607 of the outer frame hole reinforcing portion 2702 to form the trap portion 2600.

The trap portion 2600 includes a first flow path 2610, a return flow path 2611, a second flow path 2612, and a down flow path 2613.

The first flow path 2610 is spatially connected to the gap T and extends into the space between the upper surface of the first guide wall 2606 and the lower surface of the second guide wall 2607.

The return flow path 2611 is spatially connected to the first flow path 2610 and switches the fluid flow direction of the first flow path 2610 in the opposite direction.

The second flow path 2612 is spatially connected to the space of the return flow path 2611 and extending into a space between an upper surface 2413 of the circuit receiving portion 2410 and a lower surface of the first guide wall 2606.

The down flow path 2613 is formed from the outlet of the second flow path 2612 along the inner side of the door inner frame 230 corresponding to the circuit protection portion 2310 to the fluid outlet 2800.

That is, the water droplet W_in generated by condensing moisture or moisture introduced through the gap T may flow through the first flow path 2610, the return flow path 2611, the second flow path 2612, and the down flow path 2613, and eventually it may not affect the circuit 2020 because it will be discharged “W_out” through the fluid outlet 2800.

The fluid outlet 2800 serves as a drain hole and a vent hole. To this end, the fluid outlet 2800 may refer to a plurality of holes passing through the lower portion of the door inner frame 230, with respect to the direction toward the cover 300.

Referring to FIG. 8 or FIG. 10, the door 200 includes the gas passage portions 2700 mentioned above.

For example, the gas passage portions 2700 are spaced along the circumferential direction around the door glass 280. In this configuration, the gas passage portions 2700 are disposed at three points including the upper one point of the door 200 and the lower two sides of the door 200 when the door 200 is viewed from the front.

Each gas passage portion 2700 is formed at a position where the door inner frame 230 and the door outer frame 240 overlap each other. Accordingly, each gas passage portion 2700 may flow and conveys the gas (e.g., moisture) inside the door glass 280 and the outside gas (e.g., dry air) of the washing machine with each other.

Each gas passage portion 2700 forms a convection path of the gas (e.g., moisture or dry air) to the fluid outlet 2800 of the door inner frame 230 via the door glass 280 and the first passage groove portions 2704 of the door outer frame 240 through the second passage groove portions 2705 and the third passage groove portions 2404.

The door outer frame 240 includes a partition wall 247 formed on the inner side of the door outer frame 240 with respect to a position between the outer frame hole reinforcing portion 2702 and the outer edge 248 of the door outer frame 240.

The door outer frame 240 forms an inner passage portion 246 which is not connected between the end of the partition wall 247 and the circuit receiving portion 2410.

The inner passage portion 246 becomes a part of the passage of the gas exiting the second passage groove portions 2705.

Each gas passage portion 2700 includes a first passage groove portion 2704 spatially connected with the inner space of the door glass 280 and an extended space portion 2710. The extended space portion 2710 is spatially connected to the first passage groove portion 2704, and partitioned by the outer frame hole portion 2701, the outer frame hole reinforcing portion 2702 and the glass edge portion 284 of the door glass 280, and has a relatively large volume relative to the volume of the first passage groove portion 2704.

The gas passage portion 2700 includes the second passage groove portion 2705 spatially connected to the extension space portion 2710, and the third passage groove portion 2604 which is spatially connected to the second passage groove portion 2705 and overlapping with the outer position of the groove portion 2705.

The gas passage portion 2700 includes a convection space portion 2711 which is formed from the third passage groove portion 2604 to the fluid outlet 2800 of the lower portion of the door inner frame 230 via the inner space of the door 200 or the inner passage portion 246.

The moisture “A_in” of the interior space of the door glass 280 may be prevented from condensing on the inner surface of the door glass 280 by being discharged A_out through the fluid outlet 2800 or by convection action with dry air from the outside of the washing machine, after becoming the gas “A_cir” flowing through the first passage groove portion 2704 of the gas passage portions 2700, the extended space portion 2710, the second passage groove portions 2705, and the third passage groove portions 2604.

As described above, in the wall-mounted washing machine and the door thereof according to the embodiments of the disclosure, there is an effect in that moisture generated in the door may be removed by convection action with the outside air.

In addition, there is an advantage in that moisture flowing into a gap of the door may be removed.

Further, there are advantages provided herein of solving the problems of moisture and water related to the door, as well as water tight securing of the washing machine during operation, and preventing accidental water leakage.

The above description is merely illustrative of the technical idea of the present disclosure and various changes and modifications may be made without departing from the essential characteristics of the present disclosure. Therefore, the embodiments described in the present disclosure are not intended to limit the scope of the present disclosure, but are intended to illustrate and not limit the scope of the present disclosure. The scope of protection of the present disclosure should be construed according to the following claims, and all technical ideas which are equivalent or equivalent thereto should be interpreted as being included in the scope of the present disclosure.

What is claimed is:

1. A wall mounted washing machine comprising:
a cabinet having front and rear surfaces;
a tub disposed in the cabinet to store wash water;
a front panel disposed in the tub;
a drum rotatably installed in the tub;
a cover installed in the front panel and comprising a door hinge; and
a door rotatably coupled to the door hinge and comprising a door glass supported by a door inner frame and a door outer frame coupled to each other,
wherein the door comprises a trap portion disposed around the door glass and for guiding a fluid which is operable to flow through a gap between the door glass and the door inner frame.

2. The wall mounted washing machine according to claim 1, wherein the door further comprises a disk-like structure and wherein the disk-like structure comprises a display circuit disposed in a lower position of the door glass.

3. The wall mounted washing machine according to claim 2, wherein the door is a protruding structure having a thin outer thickness which gradually increases toward a center thereof.

4. A wall mounted washing machine comprising:
a cabinet forming an exterior shape;
a tub disposed in the cabinet to store wash water;
a drum rotatably installed in the tub;
a cover coupled to the cabinet; and
a door comprising an inner frame and an outer frame, combined with each other, and operable to shield the cover and to mount a door glass,
wherein the door further comprises a trap portion formed on the inner frame and the outer frame and disposed with respect to a lower side of the door glass.

5. The wall mounted washing machine according to claim 4, wherein the trap portion defines a fluid flow path from a gap between the door glass and the inner frame to a fluid outlet of the inner frame.

6. The wall mounted washing machine according to claim 5, wherein the door glass comprises:
a glass body having a bulged and substantially cap shape and extending toward the drum;
a glass inclined portion in which an outer diameter gradually increases with respect to a direction from the glass body toward the inner frame;
a glass extension portion extending in a direction from an end of the glass inclined portion toward the inner frame; and
a glass edge portion bent in shape from an end of the glass extension portion in an outward direction perpendicular to the glass extension portion.

7. The wall mounted washing machine according to claim 6, wherein the door glass further comprises a plurality of positioning protrusions disposed spaced apart from both sides of an upper portion of the glass edge portion.

8. The wall mounted washing machine according to claim 7, wherein the door glass further comprises a flat portion disposed on a lower side of the glass edge portion.

9. A door for a washing machine, the washing machine comprising a cabinet forming an exterior shape; a tub disposed in the cabinet to store wash water; a drum rotatably installed in the tub; and a cover coupled to the cabinet, the door comprising:
an inner frame;
an outer frame;
a display circuit;
a door glass; and
a trap portion formed on the inner frame and the outer frame and disposed with respect to a position between the door glass and the display circuit.

10. The door according to claim 9, wherein the inner frame comprises:
an inner frame hole portion open in a thickness direction from a center of the inner frame and operable to mount the door glass;
a plurality of support ribs protruding from an inner side of the inner frame hole portion and spaced apart in a circumferential direction of the inner frame hole portion and operable to support an edge portion of the door glass in a radial direction; and
a wall body extending along a circumferential direction of the inner frame from an inner side of the inner frame hole and operable to connect the plurality of supporting ribs together.

11. The door according to claim 10, wherein the wall body of the inner frame is more protruded from the inner side of the inner frame hole portion than a protrusion height of a support rib of the plurality of support ribs.

12. The door according to claim 11, wherein the wall body comprises a closed loop-type wall structure which is formed and combined to correspond with a shape of the edge portion of the door glass.

13. The door according to claim 12, wherein the wall body comprises:
a plurality of positioning groove portions disposed to be spaced apart from each other from an upper portion of the wall body to correspond with positioning protrusions of the edge portion of the door glass; and
a first guide wall integrally disposed on a lower side of the wall body to not be in contacted with a corresponding flat portion of the edge portion of the door glass, and wherein further the first guide wall is spaced apart below a gap between the door glass and the inner frame.

14. The door according to claim 13, wherein the gap comprises an opening formed between an outer side of the edge portion of the door glass and an inner side of the inner frame hole portion of the inner frame.

15. The door according to claim 14, wherein the outer frame comprises:
an outer frame hole portion open in a thickness direction from a center of the outer frame and operable to mount the door glass and to support an inner side of the edge portion of the door glass in a thickness direction of the door;
an outer frame hole reinforcing part spaced apart from an outside of the inner frame hole portion; and
a plurality of connecting ribs connecting the inner frame hole portion and the inner frame hole reinforcing portion together.

16. The door according to claim 15, wherein the inner frame hole reinforcing portion of the outer frame comprises a second guide wall integrally disposed on a lower side of the inner frame hole reinforcing portion to be spaced apart from and parallel to the first guide wall from a position above the first guide wall of the inner frame.

17. The door according to claim 16, wherein the outer frame further comprises a circuit receiving portion spaced apart from a lower side of the inner frame hole reinforcing portion and integrally formed on an inner side of the outer frame and operable for receiving the display circuit.

18. The door according to claim 17, wherein the first guide wall of the wall body of the inner frame is disposed within a space between an upper end of the circuit receiving portion of the outer frame and the second guide wall of the inner frame hole reinforcing portion to form the trap portion.

19. The door according to claim 18, wherein the trap portion comprises:
a first flow path spatially coupled to the gap and extending into a space between an upper surface of the first guide wall and a lower surface of the second guide wall;
a return flow path spatially coupled to the first flow path and switching a fluid flow direction of the first flow path in an opposite direction;
a second flow path spatially coupled to the return flow path and extending into a space between an upper surface of the upper end of the circuit receiving portion and a lower surface of the first guide wall; and
a down flow path formed from an outlet of the second flow path to a fluid outlet of a lower portion of the inner frame and along an inner side of the inner frame.

20. The door according to claim 19, wherein the fluid outlet comprises a plurality of holes penetrating the lower portion of the inner frame with respect to a direction toward the cover and operable to function as a drain hole.
